(19) United States
(12) Patent Application Publication
(10) Pub. No.: US 2015/0370263 A1
(43) Pub. Date: Dec. 24, 2015

(54) GAS MIXING DEVICE

(71) Applicant: SEHWA HIGH TECH CO., LTD., Wonmi-gu, bucheon-si Gyeonggi-do (KR)

(72) Inventor: Jong Hyeok KIM, Yongin-si, Gyeonggi-do (KR)

(73) Assignee: Sehwa High Tech Co., Ltd.

(21) Appl. No.: 14/766,137

(22) PCT Filed: Aug. 1, 2013
(86) PCT No.: PCT/KR2013/006931

§ 371 Date: Aug. 6, 2015

(30) Foreign Application Priority Data
Feb. 7, 2013 (KR) 10-2013-0013747

(51) Int. Cl. G05D 11/13; B01F 15/02; B01F 15/00; G05D 11/03; B01F 3/02

(52) U.S. Cl. CPC G05D 11/132; G05D 11/03; B01F 3/028; B01F 15/00331; B01F 15/026

(57) ABSTRACT

A gas mixing device is disclosed. The present invention comprises: a first electric type flow rate controller, provided with a first gas, for controlling a flow rate of the first gas; a second electric type flow rate controller, provided with a second gas to be mixed with the first gas, for controlling a flow rate of the second gas; and a first non-electric type flow rate controller for controlling the flow rate of the first gas, by receiving the first gas, when the electric power is not supplied to the first electric type flow rate controller provided in parallel to the first electric type flow rate controller. According to the present invention, the gas mixing device for implementing a powerless operation during a power outage and guaranteeing high accuracy of a gas mixing ratio is provided.

### TECHNICAL FIELD

The present invention relates to a gas mixing device, and more particularly, to a gas mixing device capable of performing a powerless operation during a power outage and guaranteeing a gas mixing ratio with high accuracy.

### BACKGROUND ART

Magnesium which comes to the fore as the next environment-friendly light material is the lightest metal, and allows for a light-weight transfer machine and electronic device. Since a magnesium material is applied to various components, it is expected that the demand for the magnesium will greatly increase. However, since a magnesium alloy has its high affinity with oxygen and high steam pressure, when the molten metal is exposed to an atmosphere, oxidation and ignition violently occur. For this reason, in order to suppress the oxidation and ignition in an alloy melting and casting process, it is necessary to protect the molten metal by applying a protective gas (99.5% of N2 and 0.5% of SO2 or SF6) onto the surface of the molten metal. Since a mixing ratio of the protective gas influences the quality of the magnesium, it is necessary to accurately control the mixing ratio thereof.

Unlike a general gas mixing device, a gas mixing device used for such a purpose needs to perform a powerless operation during a power outage in order to obtain safety in a casting process, and needs to solve a technical need to maximize the accuracy of the mixing ratio of SF6.

Meanwhile, since the amount of gas filling in the cylinder is limited, when the gas is used up to a predetermined amount, the gas needs to be replaced with a new gas. In order to replace the gas, an operator repeatedly checks the amount of residual gas in the cylinder, and when the amount of residual gas is equal to or less than a predetermined amount, the cylinder needs to be replaced with a new cylinder filled a new gas.

However, if the cylinder is not replaced with a new cylinder at a proper timing, the supply of the gas to the mass flow controller from the cylinder is stopped, and if the cylinder is replaced with a new cylinder too early, the gas is greatly discharged without being used.

### DISCLOSURE

### Technical Problem

An object of the present invention is to provide a gas mixing device capable of performing a powerless operation during a power outage and guaranteeing a gas mixing ratio with high accuracy.

### Technical Solution

In order to achieve the above object, the present invention provides a gas mixing device including: a first electric-type mass flow controller (110) to which a first gas is supplied and that controls a flow rate of the first gas; a second electric-type mass flow controller (130) to which a second gas to be mixed with the first gas, and that controls a flow rate of the second gas; and a first non-electric-type mass flow controller that is provided in parallel with the first electric-type mass flow controller (110), and to which the first gas is supplied to control the flow rate of the first gas when a power is not supplied to the first electric-type mass flow controller (110).

Preferably, the gas mixing device may further include a first non-electric-type mass flow controller that is provided in parallel with the second electric-type mass flow controller (130), and to which the second gas is supplied to control the flow rate of the second gas when the power is not supplied to the second electric-type mass flow controller (130).

Further, solenoid valves that are opened when the power is blocked may be provided at gas inlets which are respectively provided at the first non-electric-type mass flow controller and the second non-electric-type mass flow controller (135).

Furthermore, solenoid valves that are closed when the power is blocked may be provided at gas inlets which are respectively provided at the first non-electric-type mass flow controller and the second non-electric-type mass flow controller (135).

Moreover, the gas mixing device may further include an automatic transfer switch that measures the amount of residual gas or a gas pressure of a cylinder which supplies the second gas, and switches a supply line of the second gas to another cylinder when the measured value is equal to or less than a predetermined critical value.

### Effect of the Invention

According to the present invention, it is possible to provide a gas mixing device capable of performing a powerless operation during a power outage and guaranteeing a gas mixing ratio with high accuracy.

In addition, according to the present invention, it is possible to prevent a magnesium explosion accident by ensuring the safety of a magnesium casting process.

### DESCRIPTION OF DRAWINGS

FIG. 1 is a structural diagram of a gas mixing device according to an embodiment of the present invention.

FIG. 2 is a flowchart for describing an altering operation principle between an electric-type mass flow controller and a non-electric-type mass flow controller of the gas mixing device according to the embodiment of the present invention.

FIG. 3 is a flowchart for describing an operation principle of an automatic transfer switch (190) in FIG. 1.

### BEST MODE

Hereinafter, the present invention will be described in detail with reference to the drawings. It should be noted that the same components will be assigned the same reference numerals in the drawings. The detailed description of the known functions and configurations that may unnecessarily obscure the gist of the present invention will be omitted.

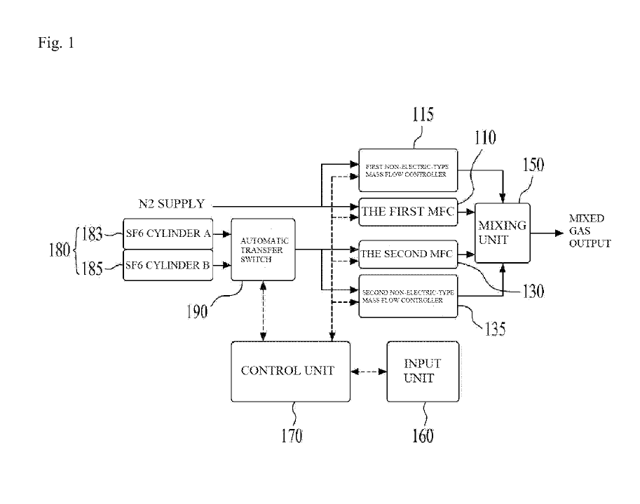

FIG. 1 is a structural diagram of a gas mixing device according to an embodiment of the present invention. Referring to FIG. 1, the gas mixing device according to the embodiment of the present invention includes a first electric-type mass flow controller 110, a first non-electric-type mass flow controller 115 that is provided in parallel with the first electric-type mass flow controller 110, a second electric-type mass flow controller 130, a second non-electric-type mass flow controller 135 that is provided in parallel with the second electric-type mass flow controller 130, a mixing unit 150, an input unit 160, a control unit 170, a cylinder unit 180, and an automatic transfer switch 190.

At the time of implementing the present invention, the first electric-type mass flow controller 110, and the second electric-type mass flow controller 130 may be respectively MFCs (Mass Flow Controllers), and the first non-electric-type mass flow controller 115 and the second non-electric-type mass flow controller 135 may be respectively positive displacement flow meters.

The positive displacement flow meter basically does not need external energy such as electricity, performs the measurement by operating a rotor using energy of a fluid, and calculates a flow rate by obtaining the sum of the inflow number of a fluid and the outflow number and the volume of a container per unit time through the repeated inflow and outflow of the fluid into the container having a predetermined volume.

A first gas such as nitrogen gas (N2) is supplied to the first electric-type mass flow controller 110. The flow rate of the supplied first gas is controlled, and the first gas of which the flow rate is controlled is discharged to the mixing unit 150.

Meanwhile, a second gas such sulfur hexafluoride (SF6) or sulfur dioxide (SO2) is supplied to the second electric-type mass flow controller 130. The flow rate of the supplied second gas is controlled, and the second gas of which the flow rate is controlled is discharged to the mixing unit 150.

Meanwhile, the first gas and the second gas are mixed in the mixing unit 150, and the mixed gas is discharged to a distributor (not shown).

However, when power is not supplied to the first electric-type mass flow controller 110 and the second electric-type mass flow controller 130 due to a power outage, the first non-electric-type mass flow controller 115 and the second non-electric-type mass flow controller 135 are respectively provided in parallel with the first electric-type mass flow controller 110 and the second electric-type mass flow controller 130 in order to continuously realize the functions of controlling the flow rates of the first gas and the second gas in the present invention.

That is, when an external power is not supplied due to the power outage, the first gas supplied to the first electric-type mass flow controller 110 is supplied to the first non-electric-type mass flow controller 115, and the first non-electric-type mass flow controller 115 controls the flow rate of the supplied first gas, and discharges the first gas of which the flow rate is controlled to the mixing unit 150.

In addition, when the external power is not supplied due to the power outage, the second gas supplied to the second electric-type mass flow controller 130 is supplied to the second non-electric-type mass flow controller 135, and the second non-electric-type mass flow controller 135 controls the flow rate of the supplied second gas, and discharges the second gas of which the flow rate is controlled to the mixing unit 150.

To achieve this, solenoid valves that are opened at the time of blocking the power are preferably provided at gas inlets that are respectively provided in the first non-electric-type mass flow controller 115 and the second non-electric-type mass flow controller 135.

In addition, when the external power is not supplied due to the power outage, solenoid valves that are closed at the time of blocking the power may be provided at the gas inlets that are respectively provided in the first electric-type mass flow controller 110 and the second electric-type mass flow controller 130 such that the supply of the gases to the first electric-type mass flow controller 110 and the second electric-type mass flow controller 130.

Meanwhile, solid lines between the respective components in FIG. 1 represent the flow of the gas, and dotted lines between the respective components represent the flows of a control signal and a power.

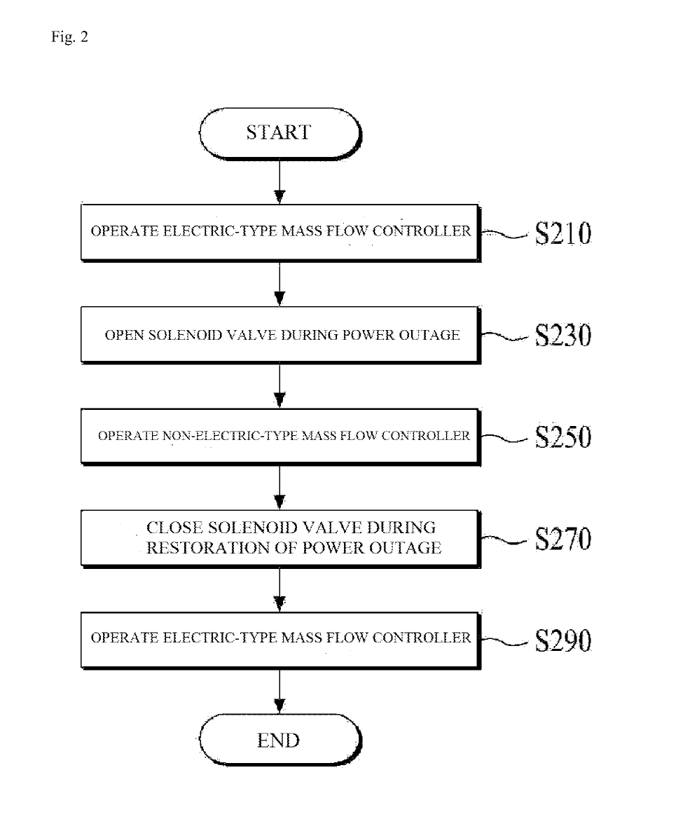

FIG. 2 is a flowchart for describing an altering operation principle of the electric-type mass flow controller and the non-electric-type mass flow controller in the gas mixing device according to the embodiment of the present invention. Referring to FIG. 2, when the altering operation principle of the electric-type mass flow controller and the non-electric-type mass flow controller in the gas mixing device according to the embodiment of the present invention is described, the electric-type mass flow controller which is the MFC is normally operated in a state in which the power is supplied (S210).

Meanwhile, when the supply of the power to the control unit 170 is stopped due to the power outage, the supply of the power to the solenoid valves provided at the gas inlets of the non-electric-type mass flow controllers from the control unit 170 is stopped, and thus, the valves are opened (S230).

Meanwhile, in this case, the supply of the power to the solenoid valves provided at the gas inlet of the electric-type mass flow controllers is stopped, and the solenoid valves provided at the electric-type mass flow controllers are closed when the power is not supply.

For this reason, the supply of the gas to the electric-type mass flow controller is stopped during the power outage, and when the supply of the gas to the non-electric-type mass flow controllers is performed, the gas mixing device according to the present invention can be continuously operated in a normal state in an emergency state such as the power outage (S250).

Meanwhile, when the power outage is restored and the supply of the power to the control unit 170 is resumed, the power is supplied to the solenoid valves provided at the gas inlets of the non-electric-type mass flow controllers from the control unit 170, and thus, the valves are closed (S270).

Meanwhile, in this case, the supply of the power to the solenoid valves provided at the gas inlets of the electric-type mass flow controllers is resumed, and the solenoid valves provided at the electric-type mass flow controllers are opened when the power is supplied.

Accordingly, the supply of the gas to the electric-type mass flow controllers is resumed again at the time of restoring the power outage, and when the supply of the gas to the non-electric-type mass flow controllers is stopped, the gas mixing device according to the present invention can be continuously operated in the normal state (S290).

Meanwhile, referring to FIG. 1, a plurality of cylinders including a cylinder A (183) and a cylinder B (185) is provided in parallel in the cylinder 180 that supplies the second gas such as SF6 to the second electric-type mass flow controller 130 and the second non-electric-type mass flow controller 135.

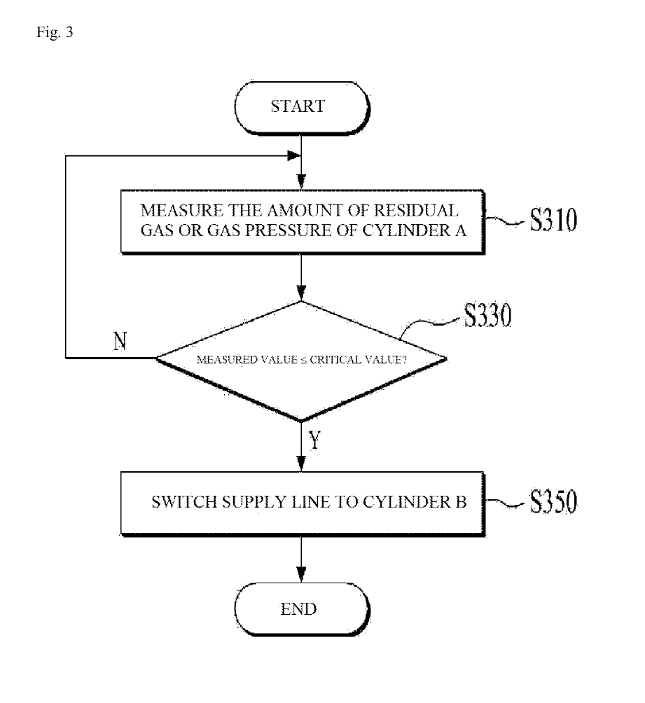

Meanwhile, the automatic transfer switch 190 provided with a sensor that measures the amount of residual gas or a gas pressure of the cylinders 183 and 185 is provided within the cylinder 180, and FIG. 3 is a flowchart for describing the operation principle of the automatic transfer switch 190 of FIG. 1.

That is, the automatic transfer switch 190 measures the amount of residual gas or the gas pressure of the cylinder A (813), compares the measured value with a predetermined critical set value (S330), and automatically performs a function of switching a supply line of the second gas such that the supply of the second gas from the cylinder A (183) is stopped and the supply of the second gas from the cylinder B (185) is performed when it is determined that the measured value is equal to or less than the predetermined critical set value (S350).

To achieve this, the automatic transfer switch 190 preferably includes a storage that stores a critical set value input through the input unit 160 by an operator, and a control module that compares the measured value with the critical set value, determines whether or not to switch the supply line, and switches the supply line.

As described above, according to the automatic transfer switch function of the gas supply line of the automatic transfer switch 190, it is possible to prevent the problem that the supply of the gas to the second mass flow controllers 130 and 135 from the cylinder is stopped since the operator does not replace the cylinder 185 with a new one at a proper timing, and thus, it is possible to obtain high accuracy of a gas mixing ratio.

While the application examples and the preferred embodiments of the present invention have been illustrated and described, the present invention is not limited to the aforementioned particular embodiments and application examples. It is apparent to those skilled in the art that various modification examples are possible without departing from the gist of the present invention claimed in the claims, and such modification examples should not be understood as being independent from the technical spirit or prospect of the present invention.

The terminologies used in the present invention are for the purpose of describing the particular embodiments only and are not intended to be limiting of the present invention. The singular forms are intended to include the plural forms as well, unless the context clearly indicates otherwise. It will be further understood that the terms “comprises”, “comprising”, “include”, and “including”, when used herein, specify the presence of stated features, numbers, steps, operations, elements, components or combinations thereof, but do not preclude the presence or addition of one or more other features, numbers, steps, operations, elements components or combinations thereof.

What is claimed is:

1. A gas mixing device comprising:
a first electric-type mass flow controller (110) to which a first gas is supplied and that controls a flow rate of the first gas;
a second electric-type mass flow controller (130) to which a second gas to be mixed with the first gas, and that controls a flow rate of the second gas; and
a first non-electric-type mass flow controller that is provided in parallel with the first electric-type mass flow controller (110), and to which the first gas is supplied to control the flow rate of the first gas when a power is not supplied to the first electric-type mass flow controller (110).

2. The gas mixing device according to claim 1, further comprising:
a first non-electric-type mass flow controller that is provided in parallel with the second electric-type mass flow controller (130), and to which the second gas is supplied to control the flow rate of the second gas when the power is not supplied to the second electric-type mass flow controller (130).

3. The gas mixing device according to claim 2,
wherein solenoid valves that are opened when the power is blocked are provided at gas inlets which are respectively provided at the first non-electric-type mass flow controller and the second non-electric-type mass flow controller.

4. The gas mixing device according to claim 2,
wherein solenoid valves that are closed when the power is blocked are provided at gas inlets which are respectively provided at the first non-electric-type mass flow controller and the second non-electric-type mass flow controller (135).
